(19) United States
(12) Patent Application Publication
(10) Pub. No.: US 2026/0192643 A1
(43) Pub. Date: Jul. 9, 2026

(54) Pickup truck rear cover with a coating

(71) Applicant: Wenzhou Xiaolei Automotive Parts Co., Ltd., Wenzhou (CN)

(72) Inventors: Dingqi Ma, Wenzhou (CN); Shangyi Xie, Wenzhou (CN)

(21) Appl. No.: 19/024,279

(22) Filed: Jan. 16, 2025

(30) Foreign Application Priority Data
Jan. 6, 2025 (CN) 202520024533.7

(51) Int. Cl. B60J 7/14

(52) U.S. Cl. CPC B60J 7/141

(57) ABSTRACT

The present invention discloses a pickup truck rear cover with a coating. The cover comprises a frame that is detachably mounted over the rear cargo hopper. A cover panel, made of either soft material or rigid plate, is covered over the frame. The cover panel includes a top surface layer and/or an intermediate layer with ink applied to the surface of the top surface layer and cured under ultraviolet (UV) light to form a coating. Additionally, the cover panel includes a bottom surface layer, with ink applied to its surface and UV-cured to solidify the coating. This enhances the waterproof and scratch-resistant properties of the soft cover.

### CROSS-REFERENCE TO RELATED APPLICATIONS

This application claims priority benefits to Chinese Patent Application No. 2025200245337, filed on Jan. 6, 2025, the contents of which are incorporated herein by reference.

### TECHNICAL FIELD

Present invention is relevant to technical field of automotive parts, especially a pickup truck rear cover with a coating.

### BACKGROUND TECHNOLOGY

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. In order to adapt to more diverse environments, most existing pickup trucks need to be fitted with a car cover, which is made of a plurality of panels spliced together. When in use, the car cover will be folded, when not in use it will lay flat to cover the rear cargo hopper.

The existing rear car cover features poor waterproofing and anti-scratch performance, which can easily lead to the water leakage from the rear cargo hopper as well as damage to the rear car cover.

### About the Invention

The embodiments of the present invention provide a coated pickup truck rear cover to address at least the technical problem of poor weatherproofing and anti-scratch performance of the rear car cover.

In order to solve the above problems of the existing technology, the technical solution adopted in the invention is as follows:

A pickup truck rear cover with a coating, which can be detachably mounted on the pickup rear cargo hopper, characterized by comprising:

A frame, which is detachably mounted over the rear cargo hopper.

A cover Panel, made of either soft material or rigid plate, is covered over the frame. The cover panel includes a top surface layer and/or an intermediate layer, with ink applied to the surface of the top layer and cured under ultraviolet (UV) light to form a coating;

And/or:

The cover panel further includes a bottom surface layer, whose surface is also coated with UV ink and cured under ultraviolet (UV) light to form a coating.

A pickup truck rear cover with a coating provided in present invention effectively enhances the weatherproofing and anti-scratch performance of the cover panel by applying UV ink to the surface of the panel, which cures under ultraviolet (UV) light to form a coating. The ink is UV ink, comprising polymerize prepolymers, photosensitive monomer active diluent, and photo-initiators.

Further, if the cover panel is made of soft material, the soft material includes a top PVC layer and/or an intermediate mesh layer, with ink applied to the surface of the top PVC layer of the soft material and cured under UV light to form a coating. The soft material further includes a bottom PVC layer, with ink applied to its surface and cured under UV light to form a coating.

Further, if the cover panel is made of a rigid plate, the top surface layer of the panel can be fiberglass or aluminum. The rigid plate further includes an intermediate honeycomb layer, the bottom layer of the rigid plate is made of fiberglass or aluminum, with ink applied to the surface of the bottom layer, and cured under ultraviolet (UV) light to form a coating.

Further, the peripheral edges of the soft leather are provided with edging strips. This setting protects the edges of the soft material from warping and simultaneously enhancing its overall strength.

Further, ink is applied to the surface of the edging strip and cured under ultraviolet (UV) light to form a coating. This further improves the waterproof and scratch-resistant performance of the edging strip.

Further, the frame comprises a side rail, a front bar, and a rear bar, the side rail is provided with two connection part along a first direction, the front bar is pivotally connected to one of the connection part of the side rail, the rear bar is pivotally connected to the other connection portion of the side rail, The frame is provided with a flat state and a folded state. In the flat state, the front bar, the side rails, and the rear bar are placed horizontally. In the folded state, the front bar folds approximately 180 degrees along the first direction to form a two-layer folded structure with the side rail, which continues to fold this two-layer structure approximately 180 degrees along the first direction form a three-layer folded structure with the rear bar.

Further, the side rails include two first frames arranged parallel to each other along a second direction. At least one first support bar is provided perpendicular to the two first frames, with both ends of the first support bar abutting against the first frames. This setting forms an intermediate support structure for connecting the front bar and the rear bar on both sides.

Further, the front bar comprises a front frame and two second frames arranged parallel to each other along a second direction. At least one second support rod is provided perpendicular to the two second frames. A front frame is provided on one side of the two second frames, while the other side is rotationally connected to the side rails. This setting allows the front bar to be rotationally connected with the side rails to form a deformable structure capable of being laid flat or folded.

Further, the rear bar includes two third side frames arranged parallel to each other along the second direction, at least one third support bar is provided perpendicular to the two third side frames, a rear frame is provided on one side of the two third side frames, while the other side is rotationally connected to the side rails. This setting allows the rear bar to be rotationally connected with the side bar to form a deformable structure capable of being laid flat or folded.

Further, the two sides of the side rails are rotationally connected to the front bar and the rear bar respectively by an adapter. This setting allows the side rails to rotate relative to the front bar and the rear bar.

Further, the adapter part includes:

An adapter, which is provided with a recessed portion on one side and a raised portion on the other side along a third direction.

A first connector includes a first mating portion on one side, accessing the recessed portion and rotationally connected to the recessed portion by a first rotating shaft, while the other side is provided with a first fixing portion.

A second connector includes a second mating portion on one side that can be mounted on the raised portion, which can be rotationally connected to the raised portion by a second rotating shaft, while the other side is provided with a second fixing portion.

Wherein the first connector rotates relative to the adapter, and the adapter rotates relative to the second connector. This setting allows the two connectors of the adapter to rotate relative to the adapter.

Further, a first sealing zone is provided on the first connector near the adapter, a first sealing part is provided at the first sealing zone to seal between the first connector and the adapter.

A second sealing zone is provided on the adapter near the second connector, a second sealing part is provided on the second sealing zone to seal between the second connector and the adapter. This setting enhances the sealing between the first connector and the adapter as well as the sealing between the second connector and the adapter.

Further, the length of the adapter between the front bar and the side rail along the third direction is shorter than the length of the adapter set between the rear bar and the side rail along the third direction. With this setting, during the first folding, if the goal is to achieve a closely aligned and parallel state between the front panel and the rear panel, the length of the connector is equal to the combined thickness of two frames. During the second folding, if the goal is to achieve a closely aligned and parallel state between the combined structure of the front panel and the side panel with the rear panel, the length of the connector is equal to the combined thickness of three frames. Therefore, the length of the connector along the third direction between the front panel and the side panel is shorter than the length of the connector along the third direction between the rear panel and the side panel.

### DESCRIPTION OF FIGURE

FIG. 1 is an axonometric view of the cover panel made of soft material of the embodiment of the invention.

FIG. 2 is an axonometric view of the frame of the embodiment of the invention.

FIG. 3 is a schematic diagram of the cover plate of the embodiment of the invention.

FIG. 4 is a schematic diagram of the frame in the embodiment of the invention.

FIG. 5 is an enlarged view of part A in FIG. 4.

FIG. 6 is an exploded schematic diagram of an adapter in the embodiment of the invention.

FIG. 7 is a schematic diagram of the cover panel as a hard cover in the embodiment of the invention.

FIG. 8 is a schematic diagram of the cover panel as a roll cover in the embodiment of the invention.

### THE CONCRETE METHOD TO CARRY OUT

The following instruction further explains the invention's concrete implementation method.

In the description in present invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in present invention and simplify the description, and are not to be construed as limiting the present invention in any way as they indicate or imply that the device or element referred to must be constructed and operated with a specific orientation or be constructed and operated in a specific orientation.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

In this invention, unless otherwise stated, directional terms such as “axial,” “circumferential,” and “radial” generally refer to directions defined relative to the rotational axis of the rotor in the drive motor. “Inner” and “outer” refer to the inside and outside of the respective component profiles. The use of terms such as “first,” “second,” etc., is intended to distinguish between different components and does not imply any sequential or hierarchical importance. Furthermore, in the following description, when referring to the drawings, the same reference numerals in different drawings indicate the same or similar elements, unless otherwise explained.

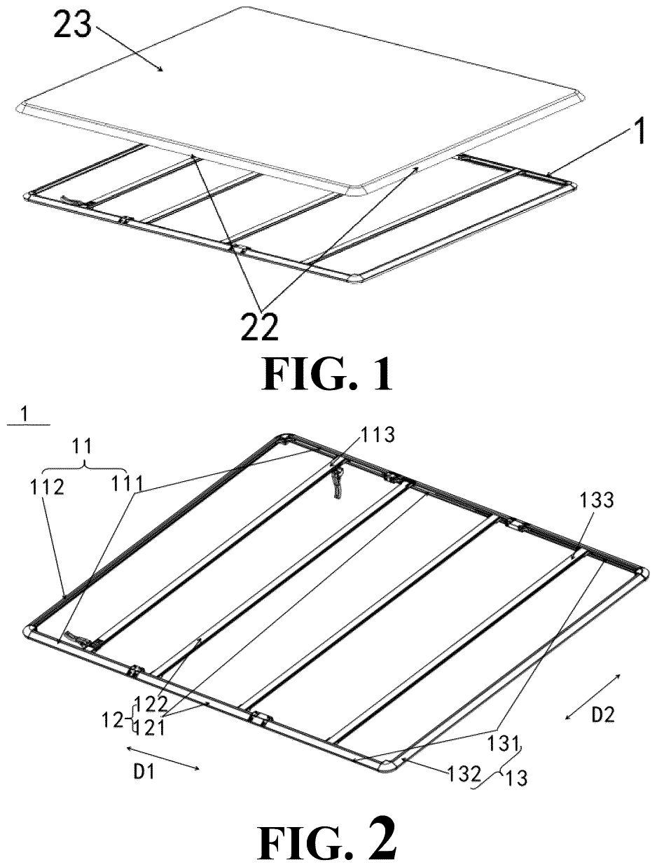

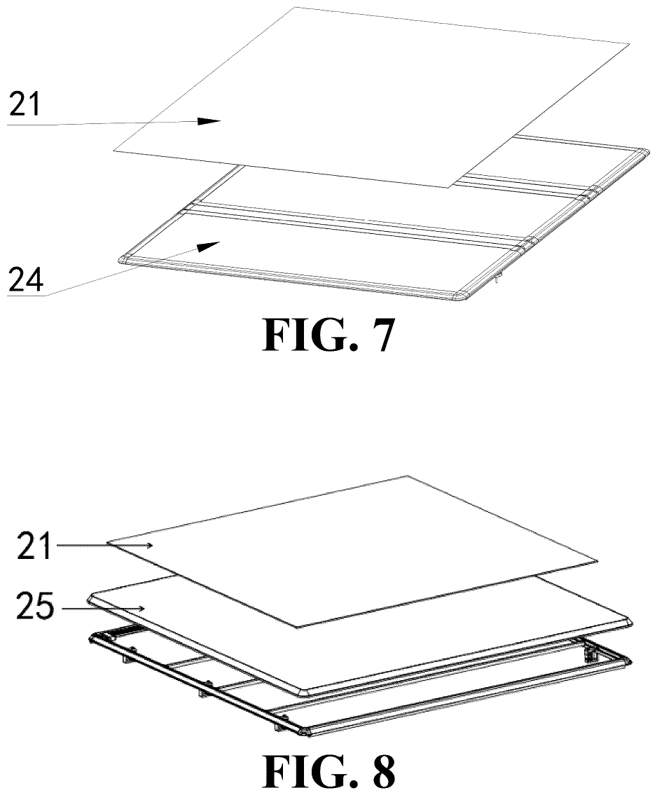

The embodiment of the invention discloses a pickup truck rear cover with a coating, which can be detachably mounted on the pickup rear cargo hopper (See FIGS. 1, 7, and 8). The assembly comprises a frame 1 and a cover panel 2. The frame 1 is detachably mounted over the rear cargo hopper. The cover panel 2, made of either soft material or rigid plate, is covered over the frame 1. The cover panel 2 includes a top layer and/or an intermediate layer, with ink applied to the surface of the top layer of the cover panel 2 and cured under ultraviolet (UV) light to form a coating 21. And/or, the cover panel 2 further include a bottom layer, whose surface is also coated with UV ink and cured under ultraviolet light to form a coating 21.

If the cover panel 2 is made of soft leather 23, the soft leather 23 mentioned above means one or more pieces, the soft leather 23 includes a top PVC layer and/or an intermediate mesh layer, with ink applied to the surface of the top PVC layer of the soft leather, and cured under ultraviolet (UV) light to form a coating 21. The soft leather further includes a bottom PVC layer, with ink applied to the surface of the bottom PVC layer and cured under ultraviolet (UV) light to form a coating 21.

If the cover plate 2 is made of rigid plate, the rigid plate mentioned above means one or more pieces, the panels are either hard cover 24 or roll cover 25. The top layer of the rigid plate can be fiberglass or aluminum. The rigid plate further includes an intermediate honeycomb layer. The bottom layer of the rigid plate is made of fiberglass or aluminum, with ink applied to the surface of the bottom layer and cured under ultraviolet (UV) light to form a coating 21.

A pickup truck rear cover with a coating provided in the embodiment of present invention effectively enhances the weatherproofing and anti-scratch performance of the cover panel 2 by applying UV ink to the surface of the panel, which cures under ultraviolet (UV) light to form a coating. The ink is UV ink, comprising polymeric prepolymers, photosensitive monomer reactive diluent, and photoinitiators.

It should be noted that polymeric prepolymers are a critical component in determining the performance of UV varnish coatings. They are the fundamental constituent of UV inks and serve as the film-forming material. The properties of the prepolymers significantly influence both the curing process and the characteristics of the cured ink film. Typically classified by their backbone structure, prepolymers are oligomers containing “C═C” unsaturated double bonds, such as acrylate, methacrylate, vinyl, or allyl groups. The primary types of these resins include: Epoxy acrylate resins, Polyurethane acrylate resins, Polyester acrylate resins, Polyether acrylate resins, Polyacrylate resins, and Unsaturated polyester resins.

Photosensitive Monomers (Reactive Diluters): In UV inks and UV varnishes, achieving a viscosity suitable for coating machines requires the addition of 20%-80% monomers to lower the viscosity of the prepolymer. These monomers also undergo polymerization, becoming part of the cured film. Reactive diluters, also known as crosslinking monomers, are functional monomers that serve multiple purposes in UV inks, including: Adjusting viscosity, Regulating curing speed, and Enhancing cured film properties. Structurally, reactive diluters contain “C═C” unsaturated double bonds, such as acrylate, methacrylate, vinyl, or allyl groups. Among these, acrylate-based monomers are the most widely used due to their rapid UV curing speed. As a result, most reactive diluters currently employed in UV inks are acrylate monomers

Photoinitiators: Photoinitiators are substances that can absorb radiant energy and undergo chemical transformations to produce active intermediates with initiator polymerization ability. They are also the main components in any UV-curable system. Photoinitiators can be categorized into two main types: hydrogen abstraction types and cleavage types.

It should also be noted that the cover plate 2 comprises a top surface, with or without a bottom surface, and optionally a intermediate layer. The material of the top or bottom surface can be PP (polypropylene), fiberglass, or aluminum profiles, while the intermediate layer features a honeycomb structure.

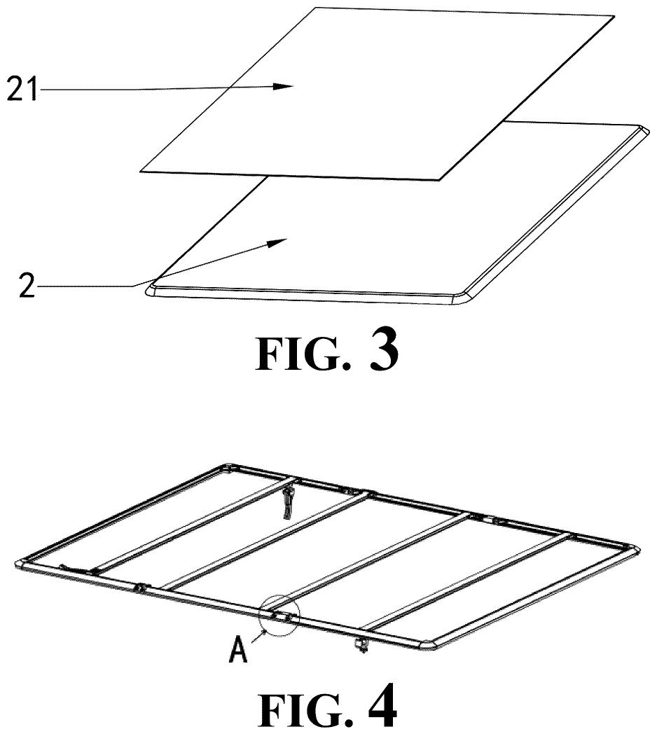

In some embodiments, as shown in FIG. 3, the peripheral edges of the cover plate 2 are provided with edge strips 22. These strips serve to protect the edges of the cover plate 2, preventing warping while simultaneously enhancing the strength of the cover plate 2.

In some embodiments, ink is applied to the surface of the edge strips 22 and cured under ultraviolet light to form a coating 21. This further enhances the waterproofing and scratch-resistant performance of the edge strips.

See FIG. 2, where the frame 1 includes a side rail 12), a front bar 11, and a rear bar 13. The side rail 12 is provided with two connecting parts along the first direction (D1). The front bar 11 is pivotally connected to one connecting part of the side rails 12, while the rear bar 13 is pivotally connected to the other connecting part of the side rail 12. The frame 1 is provided with a flat state and a folded state. In the flat state, the front bar 11, side rails 12, and rear bar 13 are placed horizontally. In the folded state, the front bar 11 folds approximately 180 degrees along the first direction (D1) to form a two-layer folded structure with the side rails 12. which continues to fold this two-layer structure approximately 180 degrees along the first direction (D1) forms a three-layer folded structure with the rear bar 13.

Continuing with FIG. 2, the side rails 12 include two first frames 121 that are provided opposite and parallel to each other along the second direction (D2). At least one first support rod 122 is provided perpendicular to the two first frames 121, with both ends of the first support rod 122 abutting against the first frame 121, forming an intermediate support structure that connects the front and rear bars on both sides.

Further refer to FIG. 2, the front bar 11 comprises two second frames 111 arranged parallel to each other along the second direction (D2) and a front border frame 112. At least one second support rod 113 is provided perpendicular to the two second frames 111. A front frame 112 is provided on one side of the two second frames 111, while the other side is pivotally connected to the side rail 12. The front bar 11 is rotationally connected with the side rail 12 to form a deformable structure capable of being laid flat and folded.

Further refer to FIG. 2, the rear bar 13 includes two third frames 131 arranged parallel to each other along the second direction (D2) and a rear frame 132. At least one third support rod 133 is provided perpendicular to the two third frames 131. A rear frame 132 is provided on one side of the two third frames 131, while the other side is pivotally connected with the side rail 12. The rear bar 13 is rotationally connected with the side rail 12 to form a deformable structure capable of being laid flat and folded.

In some embodiments, as shown in FIG. 4, the two sides of the side rail (12) are rotationally connected to the front bar 11 and the rear bar 13 by an adapter 3. The side rail 12, the front bar 11, and the rear bar 13 can rotate relative to each other.

Hereinafter, is the specific embodiments of the adapter 3 mentioned above, see FIG. 6, the adapter part 3 comprises an adapter 31, a first connector 32, and a second connector 34.

The adapter 31 is provided with a recessed portion (311) on one side and a raised portion (312) on the other side along the third direction (D3).

The first connector 32 includes a first mating portion 32 on one side, accessing the recessed portion 311 and rotationally connected to the recessed portion 311 by a first rotating shaft 36, while the other side is provided with a first fixing portion 322.

The second connector 34 is provided with a second mating portion 341 on one side, erected on a raised portion 312 and rotationally connected to the raised portion 312 by a second rotating shaft 37., while the other side is provided with a second fixing portion 342. The first connector 32 can rotate relative to the adapter 31, the adapter 31 can rotate relative to the second connector 34. The two connectors of the adapter part 3 can rotate relative to the adapter 31.

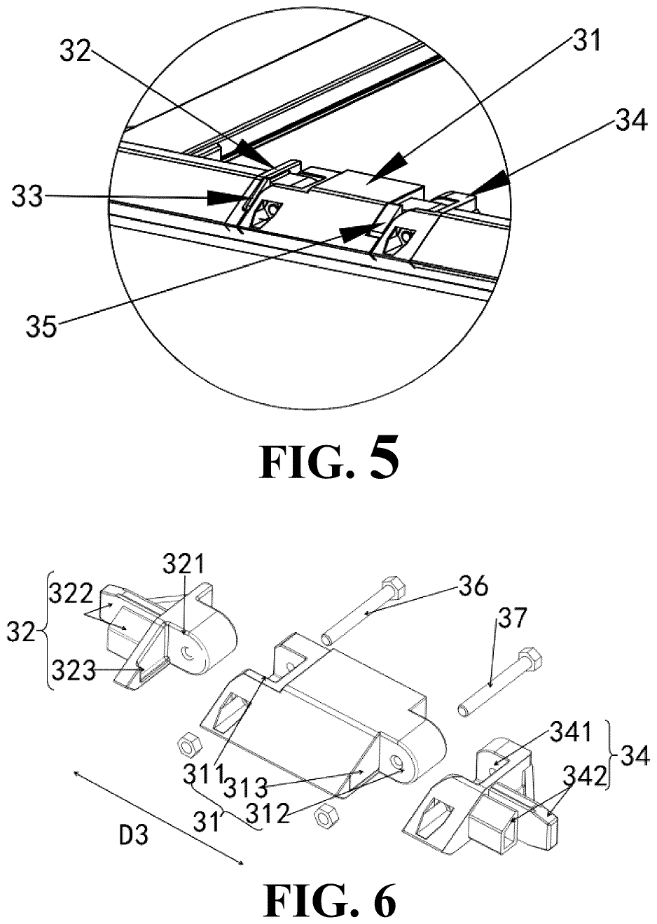

See FIGS. 5 and 6, a first sealing zone 323 is provided on the first connector 32 near the adapter 31, a first sealing part 33 is provided in the first sealing zone 323 to seal between the first connector 32 and the adapter 31. Similarly, a second sealing zone 313 is provided on the adapter 31 near the second connector 34, a second sealing part 35 is provided in the second sealing zone 313 to seal between the second connector 34 and the adapter 31. This setting enhances the sealing performance between the first connector 32 and the adapter 31 as well as the sealing between the second connector 32 and the adapter 31.

It should be noted that, as shown in FIG. 2, the length of the adapter 31 between the front bar 11 and the side rail 12 along the third direction (D3) is shorter than the length of the adapter 31 between the rear bar 13 and the side rail 12 along the third direction (D3). If the goal is to achieve a closely aligned and parallel state between the front bar and the rear bar during the first folding, the length of the adapter 31 should equal the combined thicknesses of the two rails. If it is desired to achieve a closely aligned and parallel state between the combined structure of the front bar and the side rail with the rear bar during the second folding, the length of the adapter (31) should equal the combined thicknesses of three rails. Therefore, the length of the adapter 31 between the front bar 11 and the side rail 12 along the third direction (D3) is shorter than the length of the adapter 31 between the rear bar 13 and the side rail 12 along the third direction (D3).

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A pickup truck rear cover with a coating, which can be detachably mounted on the pickup rear cargo hopper, characterized by comprising.
A frame (1), which is detachably mounted over the rear cargo hopper.
A cover panel (2), made of either soft leather or rigid plate, is covered over the frame (1).
The cover panel (2) includes a top layer and/or an intermediate layer, with ink applied to the surface of the top layer of the cover panel (2) and cured under ultraviolet (UV) light to form a coating (21).
And/or;
The cover panel (2) further includes a bottom layer, whose surface is also coated with UV ink and cured under UV light to form a coating (21).

2. A pickup truck rear cover with a coating according to claim 1, characterized in that, if the cover panel (2) is made of soft leather (23), the soft leather (23) mentioned above means one or more pieces, the soft leather (23) includes a top PVC layer and/or an intermediate mesh layer, with ink applied to the surface of the top PVC layer of the soft leather and cured under ultraviolet (UV) light to form a coating (21).

3. A pickup truck rear cover with a coating according to claim 2, characterized in that the soft leather further includes a bottom PVC layer, with ink applied to the surface of the bottom PVC layer and cured under ultraviolet (UV) light to form a coating (21).

4. A pickup truck rear cover with a coating according to claim 1, characterized in that, if the cover plate (2) is made of rigid plate, the rigid plate mentioned above means one or more pieces, the top layer of the rigid plate can be fiberglass or aluminum.

5. A pickup truck rear cover with a coating according to claim 4, characterized in that the rigid plate further includes an intermediate honeycomb layer.

6. A pickup truck rear cover with a coating according to claim 4, characterized in that the bottom layer of the rigid plate is made of fiberglass or aluminum, with ink applied to the surface of the bottom layer and cured under ultraviolet (UV) light to form a coating (21).

7. A pickup truck rear cover with a coating according to claim 1, characterized in that the peripheral edges of the soft leather (23) are provided with edging strips (22).

8. A pickup truck rear cover with a coating according to claim 7, characterized in that ink is applied to the surface of the edging strips (22), and cured under ultraviolet (UV) light to form a coating (21).

9. A pickup truck rear cover with a coating according to claim 1, characterized in that the frame (1) includes a side rail (12), a front bar (11), and a rear bar (13), the side rail (12) is provided with two connecting parts along a first direction (D1). The front bar (11) is pivotally connected to one of the connecting parts of the side rail (12), the rear bar (13) is pivotally connected to the other connecting part of the side rail (12). The frame (1) is provided with a flat state and a folded state. In the flat state, the front bar (11), side rails (12), and rear bar (13) are placed horizontally. In the folded state, the front bar (11) folds approximately 180 degrees along the first direction (D1) to form a two-layer folded structure with the side rail (12). Continuing to fold this two-layer structure approximately 180 degrees along the first direction (D1) to form a three-layer folded structure with the rear bar (13).

10. A pickup truck rear cover with a coating according to claim 9, characterized in that the side rail (12) includes two first frames (121) that are provided parallel to each other along a second direction (D2). At least one first support rod (122) is provided perpendicular to the two first frames (121), with both ends of the first support rod (122) abutting against the first frame (121).

11. A pickup truck rear cover with a coating according to claim 9, characterized in that the front bar (11) comprises two second frames (111)arranged parallel to each other along the second direction (D2) and a front frame (112). At least one second support rod (113) is provided along the direction perpendicular to the two second frames (111). A front frame (112) is arranged on one side of the two second frames (111), while the other side is rotatably connected to the side rail (12).

12. A pickup truck rear cover with a coating according to claim 9, characterized in that the rear bar (13) includes two third frames (131) arranged parallel to each other along the second direction (D2). At least one third support rod (133) is provided perpendicular to the two third frames (131). A rear frame (132) is provided on one side of the two third frames (131), while the other side is rotatably connected to the side rail (12).

13. A pickup truck rear cover with a coating according to claim 9, characterized in that the two sides of the side rail (12) are rotatably connected to the front bar (11) and rear bar (13) respectively by an adapter (3).

14. A pickup truck rear cover with a coating according to claim 9, characterized in that the adapter part (3) includes:
An adapter (31), which is provided with a recessed portion (311) on one side and a raised portion (312) on the other side along a third direction (D3).
A first connector (32) includes a first mating portion (321) on one side, accessing the recessed portion (311) and rotationally connected to the recessed portion (311) by a first rotating shaft (36), while the other side is provided with a first fixing portion (322).
A second connector (34) includes a second mating portion (341) on one side, erected on the raised portion (312) and rotationally connected to the raised portion (312) by a second rotating shaft (37), while the other side is provided with a second fixing portion (342).
Wherein the first connector (32) rotates relative to the connector (31), and the adapter (31) rotates relative to the second connector (34).

15. A pickup truck rear cover with a coating according to claim 9, characterized in that:
A first sealing zone (323) is provided on the first connector (32) near the adapter (31), a first sealing part (33) is provided in the first sealing zone (323) to seal between the first connector (32) and the adapter (31).
A second sealing zone (313) is provided on the adapter (31) near the second connector (34), a second sealing part (35) is provided in the second sealing zone (313) to seal between the second connector (34) and the adapter (31).

16. A pickup truck rear cover with a coating according to claim 9, characterized in that the length of the adapter (31) between the front bar (11) and the side rail (12) along the third direction (D3) is shorter than the length of the adapter (31) between the rear bar (13) and the side rail (12) along the third direction (D3).
